(19) United States
(12) Patent Application Publication
(10) Pub. No.: US 2004/0102188 A1
(43) Pub. Date: May 27, 2004

(54) Automatic call forwarding on airplanes

(76) Inventors: David G. Boyer, Oceanport, NJ (US); Levent Deniz Sasmazel, Holmdel, NJ (US)

Correspondence Address: DEMONT & BREYER, LLC, SUITE 250, 100 COMMONS WAY, HOLMDEL, NJ, 07733, US

(21) Appl. No.: 10/304,875

(22) Filed: Nov. 26, 2002

(51) Int. Cl. H04Q 7/20

(52) U.S. Cl. 455/422.1; 455/431

(57) ABSTRACT

An apparatus and methods for enabling the user of a mobile communications device (i.e., telephone, PDA, etc.) to receive calls directed to the device while on board an airplane are disclosed. The illustrative embodiment automatically forwards calls directed to the user's mobile communications device to an airplane communications device associated with the user (e.g., the airplane telephone closest to the user, etc.) while the user is on board the airplane.

### FIELD OF THE INVENTION

The present invention relates to telecommunications in general, and, in particular, to the automatic forwarding of calls directed to a mobile communications device to an appropriate airplane communications device.

### BACKGROUND OF THE INVENTION

Airplane passengers are instructed to turn off their mobile communications devices (e.g., telephones, pagers, personal digital assistants (PDAs), etc.) while on board the airplane in order to avoid the possibility of such devices interfering with the airplane's avionics. Some airplanes, however, do provide communications devices (e.g., telephones, etc.) that passengers can use in lieu of their mobile communications devices while on board the airplane. Although these devices can be used to place an outgoing telephone call, they do not enable a passenger to receive an incoming telephone call. Since a passenger's mobile communications device must be turned off while the passenger is on board the airplane, a passenger cannot receive any calls via his/her mobile communications device either. Thus, the need exists for a technique that enables a user to receive calls while the user is on board an airplane.

### SUMMARY OF THE INVENTION

The present invention enables a mobile communications device user to receive a call while the user is on board an airplane. In particular, the illustrative embodiment automatically forwards a call directed to a user's mobile communications device (i.e., telephone, PDA, etc.) to an airplane communications device associated with the user while the user is on board an airplane. The airplane communications device associated with a user is determined by the user's assigned seat; typically it is desirable to associate the airplane communications device closest to a user's assigned seat with that user, although the illustrative embodiment enables any airplane communications device to be associated with any user. Similarly, the illustrative embodiment also enables non-passengers (e.g., pilots, flight attendants, etc.) to be associated with a respective airplane communications device.

In this specification, the illustrative embodiment is disclosed in the context of mobile telephones; however, it will be clear to those skilled in the art how to make and use embodiments of the present invention in which a call to a wireline phone number (e.g., home phone number, office phone number, etc.) is forwarded to the airplane communications device associated with the user. In addition, while the illustrative embodiment is disclosed in the context of mobile telephones, it will be clear to those skilled in the art how to make and use embodiments of the present invention for other devices such as pagers, PDAs, etc. Consequently, the term “contact identifier” will be used as a generalization of telephone number, email address, Internet Protocol (IP) address, etc. Similarly, the term “call,” while normally used only in the context of telephones, will be used to encompass all manners of communication (e.g. email, text chat, video, etc.), and it will be clear to those skilled in the art how to make and use embodiments of the present invention for such alternative means of communication.

The illustrative embodiment comprises a method for automatically forwarding a signal directed to a user's mobile communications device to one of a plurality of airplane communications devices, the method comprising: (a) receiving a first contact identifier corresponding to the mobile communications device; (b) determining a second contact identifier corresponding to the airplane communications device associated with the user; and (c) sending a forwarding message that causes signals directed to the first contact identifier to be forwarded to the second contact identifier.

### BRIEF DESCRIPTION OF THE DRAWINGS

FIG. 1 depicts a representational diagram of exemplary airplane passenger cabin 100.

FIG. 2 depicts a flowchart of a method for automatically redirecting signals directed to a user, or to the user's mobile communications device, to the user's associated airplane communications device, in accordance with the illustrative embodiment of the present invention.

FIG. 3 depicts a flowchart of a method for automatically canceling redirection of signals directed to any user on board an airplane, or to any mobile communications device belonging to a user on board an airplane, in accordance with the illustrative embodiment of the present invention.

FIG. 4 depicts a block diagram of the salient components of an apparatus for performing the methods depicted in FIG. 2 and FIG. 3, in accordance with the illustrative embodiment of the present invention.

### DETAILED DESCRIPTION

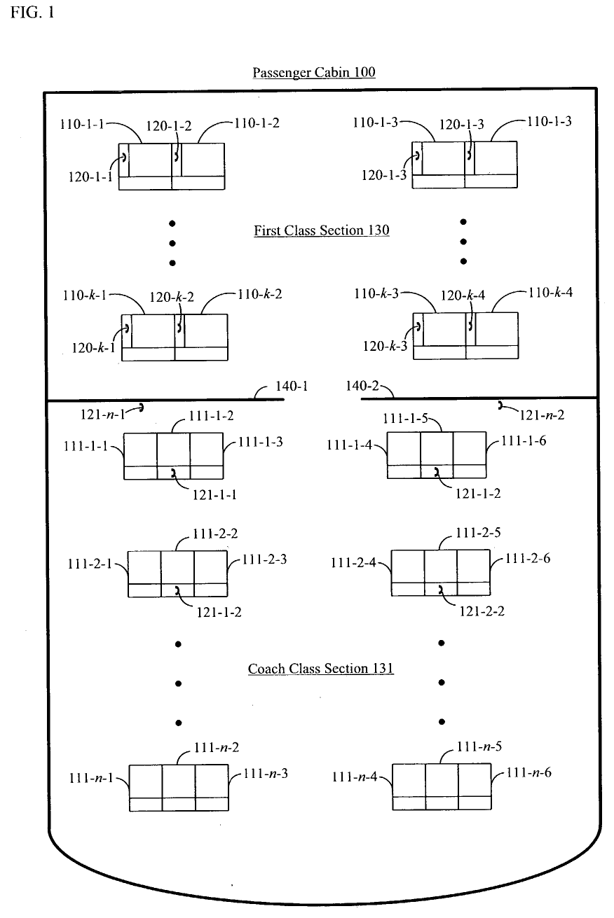

FIG. 1 depicts a representational map of exemplary airplane passenger cabin 100. Passenger cabin 100 comprises first class section 130 and coach section 131, separated by two walls 140-1 and 140-2. The division of passenger cabin 100 into two sections is merely illustrative; some airplane passenger cabins might have more than two sections (e.g., first class, business class, and coach class; etc.), while some other airplane passenger cabins might have a single section (e.g., a small jet airplane, etc.).

First class section 130 comprises seats 110-i-j and communications devices 120-i-j, where i is an integer in {1, 2, . . . , k}, k is a positive integer, and j is an integer such that 1≦j≦4. (Note that the arrangement and number of seats in first class section 130 is merely illustrative; for example, first class cabins in larger airplanes might have three aisles with 2, 3, and 2 seats, respectively.) Each seat 110-i-j has corresponding communications device 120-i-j located in the armrest for use by the passenger in seat 1 10-i-j (i.e., communications device “is associated with” seat 110-i-j). Note that locating the communications devices in respective armrests is also merely illustrative.

Coach class section 131 comprises seats 111-a-b and communications devices 121-c-d, where a is an integer in {1, 2, . . . , n,} n is a positive integer, b is an integer such that 1≦b≦6, c is an integer in {1, 2, . . . , ,n+1}, and d is an integer such that 1≦d≦2. Again note that the arrangement and number of both seats and communications devices in coach class section 131 is merely illustrative).

As shown in FIG. 1, in coach class section 131 there is one communications device 121 for every three seats 111. Specifically, for each row R, where R is an integer such that 2≦R≦n, seats 111-R-1, 111-R-2, and 111-R-3 share communications device 121-(R-1)-1 (i.e., communications device 121-(R-1)-1 “is associated with” seats 111-R-1, 111-R-2, and 111-R-3.) Similarly, for each row R, where R is an integer such that 2≦R≦n, communications device 121-(R-1)-2 is associated with seats 111-R-4, 111-R-5, and 111-R-6. For R=1 (i.e., the first row), communications device 121-n-1, which is mounted on dividing wall 140-1, is associated with seats 111-1-1, 111-1-2, and 111-1-3, and communications device 121-n-2, which is mounted on dividing wall 140-2, is associated with seats 111-1-4, 111-1-5, and 111-1-6. In some airplanes, communications devices 120 might be the same as communications devices 121, while in some other airplanes communications devices 120 might be different than communications devices 121 (e.g., data/voice terminals versus voice-only phones, free use phones versus credit-card-enabled phones, etc.)

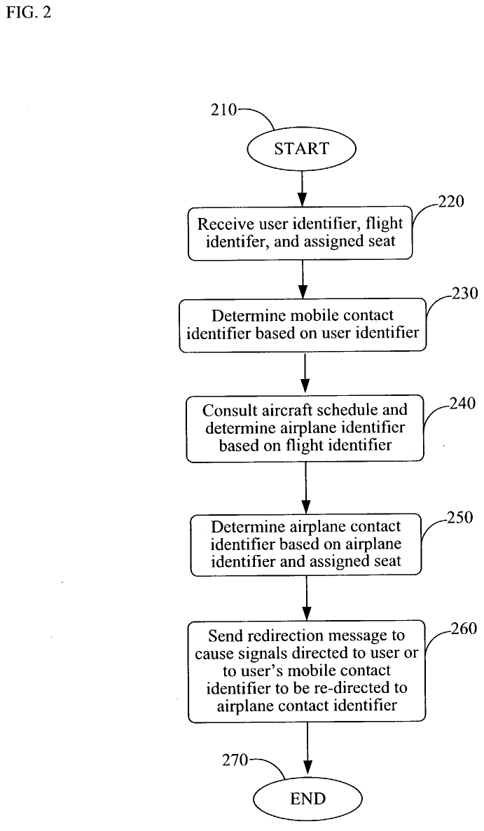

FIG. 2 depicts a flowchart of an illustrative method for automatically redirecting a signal directed to a user's mobile communications device (or to a user, in the case of peer-to-peer) to the user's associated airplane communications device, in accordance with the illustrative embodiment of the present invention. This method is to be invoked when the user boards the airplane.

At task 220, a user identifier, a flight identifier, and an assigned seat are received. A user identifier is a string of symbols that uniquely identifies a user, such as a passenger identification number, social security number, etc. A flight identifier is a string of symbols that uniquely identifies a particular flight; in some embodiments this might be a concatenation of a flight number and a date (e.g., “1452|10-31-2002”, etc.). An assigned seat is a string of symbols that uniquely identifies a particular airplane seat (e.g., “12B”, etc.).

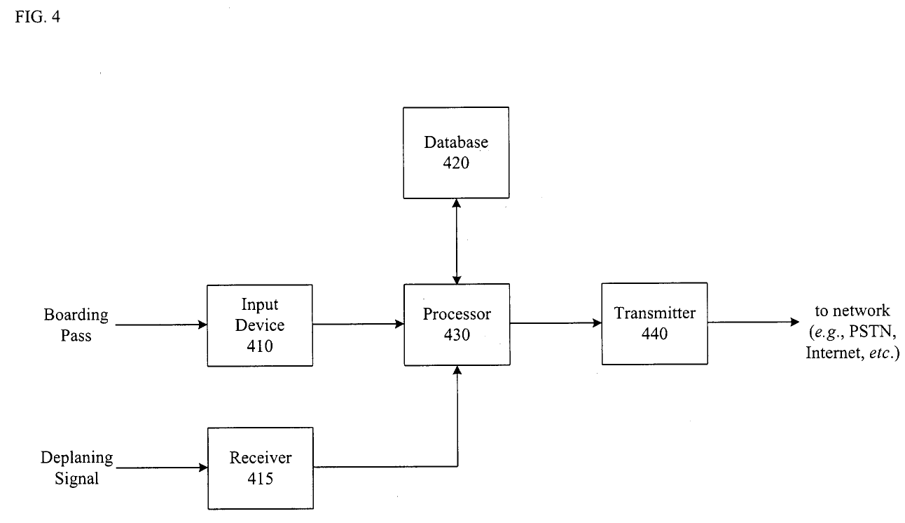

In some embodiments, such as in the apparatus disclosed below in the description of FIG. 4, these data (i.e., the user identifier, flight identifier, and assigned seat) are received by a receiver and forwarded to a processor. In some other embodiments, a processor may receive these data from a specified memory location in a shared memory, as is well understood in the art. In some other embodiments, a processor may explicitly receive just the user identifier (either via a message from a receiver or via shared memory), and then receive the flight identifier and assigned seat by submitting a query to a database, as is well-known in the art.

At task 230, the mobile contact identifier of the user is determined based on the user identifier received at task 220. In some embodiments, the mobile contact identifier can be determined by a lookup in a memory (e.g., database, flat file, random-access memory, etc.), as is well understood in the art, while in some other embodiments, the user identifier might be the mobile contact identifier itself, in which case no memory lookup is required. An apparatus that performs this task is disclosed below in the description of FIG. 4.

At task 240, the airplane identifier of the flight that the user is taking is determined based on (i) the flight identifier received at task 220, and (ii) an aircraft schedule that associates airplane identifiers (e.g., the analog of a “Vehicle Identification Number (VIN)” for airplanes, etc.) with flight identifiers. As is well understood in the art, the aircraft schedule might be stored in a memory, and the airplane identifier determined by a lookup of this memory. An apparatus that performs this task is disclosed below in the description of FIG. 4.

At task 250, an airplane contact identifier (i.e., the contact identifier associated with an airplane communications device) is determined based on: (i) the airplane identifier determined at task 240, and (ii) the assigned seat received at task 220. Again, this task can be performed by a memory lookup, as is the case for the apparatus disclosed below.

At task 260, a redirection message is sent which causes signals directed to the mobile contact identifier to be re-directed to the airplane contact identifier. As is well understood in the art, for telephone calls the redirection message is a forwarding message sent to the Public Switched Telephone Network (PSTN), and the PSTN routes the message to the appropriate switch, which causes: (i) the forward flag to be enabled in the record for the mobile phone number, and (ii) the forwarding number in this record to be set to the airplane contact identifier. For email messages, the redirection message is a forwarding message sent over the Internet to the appropriate email server to establish forwarding of messages directed to the mobile email address to the airplane device email address, as is well understood in the art. For peer-to-peer communications employing the Session Initiation Protocol (SIP), such as instant messaging (IM), the redirection message is an update message sent over the Internet to the appropriate SIP server to update the user's IP address to the airplane device IP address, as is well understood in the art. Thus, the term “redirection message,” as used in this specification encompasses all messages of this type (e.g., forwarding message, update message, etc.) for all manners of communication.

The method of FIG. 2 terminates after completion of task 260. Upon termination of this method, any signal directed to the user's mobile communications device is automatically forwarded to the appropriate airplane communications device, and any peer-to-peer signal directed to the user is automatically directed to the appropriate airplane communications device.

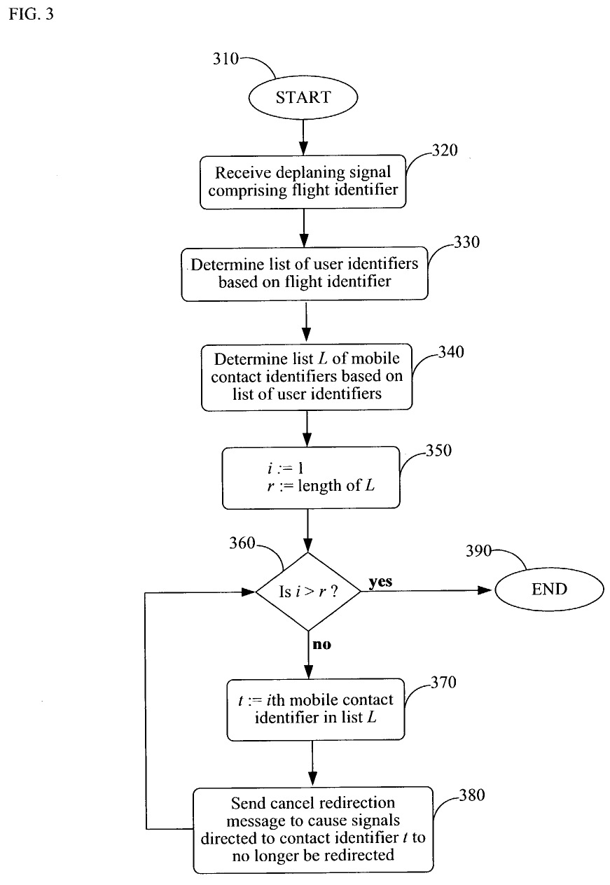

FIG. 3 depicts a flowchart of a method for automatically canceling redirection of signals directed to any mobile communications device belonging to a user on board an airplane (or to any user on board an airplane, in the case of peer-to-peer), in accordance with the illustrative embodiment of the present invention. This method is to be invoked when deplaning of the airplane commences.

At task 320, a deplaning signal comprising a flight identifier is received; as described above, a flight identifier is a string of symbols that uniquely identifies a particular flight (e.g., “1452|10-31-2002”, etc.)

At task 330, a list of user identifiers is determined based on the flight identifier received at task 220. In some embodiments, this list of user identifiers, which corresponds to the users on the specified flight (passengers, flight attendants, pilots, etc.), can be determined by a memory lookup (e.g., database query, etc.), as is well understood in the art. An apparatus that performs this task is disclosed below in the description of FIG. 4.

At task 340, a list L of mobile contact identifiers corresponding to the list of user identifiers is determined. Again, this task can be performed by a memory lookup (e.g., database lookup, etc.), as is the case for the apparatus disclosed below. For peer-to-peer communications, the mobile contact identifier will correspond to a user, rather than a device (e.g., telephone number, IP address, etc.)

At task 350, variable i is set to the value 1, and variable r is set to the length of list L.

At task 360, the value of i is compared to the value of r. If i>r, the method ends (390); otherwise, execution proceeds at task 370.

At task 370, variable t is set to the i^{th} element of list L. As is well understood in the art, setting the value of t can be accomplished via an appropriate data structure/operation (e.g., indexed array, queue with successive head operations, etc.)

At task 380, a cancel redirection message is sent which causes signals directed to contact identifier t to no longer be redirected. As is well understood in the art, for telephone calls the cancel redirection message is a cancel forwarding message sent to the PSTN, and the PSTN routes the message to the appropriate switch, which causes: (i) the forward flag in the table entry for the mobile phone number to be disabled, and (ii) the forwarding number in that table entry to be cleared. For email messages, the redirection message is a cancel forwarding message sent over the Internet to the appropriate email server to terminate forwarding of messages directed to the mobile email address, as is well understood in the art. For peer-to-peer communications, the redirection message is an update message sent over the Internet to the appropriate SIP server to revert the user's IP address back to the previous (i.e., mobile device) IP address, as is well understood in the art. Thus, the term “cancel redirection message,” as used in this specification encompasses all messages of this type (e.g., cancel forwarding message, update message, etc.) for all manners of communication. After completion of task 380, execution of the method continues at task 360.

As will be appreciated by those skilled in the art, in some embodiments the methods of FIG. 2 and FIG. 3 might apply only to users who choose to subscribe to a forwarding service. The forwarding service could be offered by a carrier (e.g., AT&T, etc.), an airline (e.g., Continental, etc.), or by a partnership between a carrier and an airline. In such embodiments, when a user boards the airplane, the method of FIG. 2 would be preceded by a check (via database query, for example) to determine if the user is a subscriber to the forwarding service. The method of FIG. 2 would subsequently be performed only if the user is in fact a subscriber. Similarly, in the method of FIG. 3, at task 330, when a list of user identifiers is determined based on a flight identifier, a user identifier (which corresponds to a particular passenger/pilot/flight attendant on the flight) would only be added to the list if the user is a subscriber to the forwarding service.

As will also be appreciated by those skilled in the art, in some embodiments the user might have the ability to enable “call blocking” for the redirection of calls to the airplane communications device. Call blocking is a service well-known in the art in which a user can specify a set of originating contact identifiers from which the user wishes to accept incoming calls. Call blocking thus filters out all incoming calls except those calls originating from a contact identifier on the user-specified list. As is well-known in the art, a typical user interface for call blocking administration is a voice-based menu through which a user can enter commands (e.g., enable call blocking, disable call blocking, add/delete a contact identifier to/from a list, etc.) via keypad entry or voice using a telephone or some other communications device.

FIG. 4 depicts a block diagram of the salient components of an apparatus for performing the methods of FIG. 2 and FIG. 3, in accordance with the illustrative embodiment of the present invention. As shown in FIG. 4, the apparatus comprises input device 410, receiver 415, database 420, processor 430, and transmitter 440.

Input device 410 receives a user identifier, as described above in task 220 of the method of FIG. 2. In some embodiments, input device 410 might be an electronic device stationed at the door of the gate that scans a user's boarding pass before the user can proceed to board the plane. (As will be familiar to air travel passengers, such electronic devices are currently used in some airports to verify that a user is indeed a proper passenger of the flight.) In other embodiments, input device 410 might read the user identifier from another item, such as a frequent flyer card, credit card, driver's license, ticket receipt, passport, or some other kind of identifier card. As will be understood to those skilled in the art, input device 410 might read signals from these items electronically, or via another method (e.g., optical barcode, keyboard entry, etc.)

Input device 410 sends the information it receives to processor 430 (disclosed below). In some embodiments input device 410 might explicitly receive the flight identifier and assigned seat in addition to the user identifier (e.g., directly from a user's boarding pass, etc.), in which case input device 410 performs task 220 in its entirety. In some other embodiments, only the user identifier might be explicitly received, in which case the flight identifier and assigned seat corresponding to the user must be determined (e.g., via a memory lookup, etc.), in which case database 420 and processor 430 (disclosed below) also participate in task 220.

Receiver 415 receives a deplaning signal comprising a flight identifier, as described above in task 320 of the method of FIG. 3, and forwards the signal to processor 430 (disclosed below). As will be appreciated by those skilled in the art, in some embodiments receiver 415 might receive a wireless electromagnetic deplaning signal, while in other embodiments receiver 415 might receive another kind of deplaning signal (e.g., wireline electromagnetic signal, etc.)

Database 420 stores persistent information, as is well known in the art. In some embodiments database 420 might be located on a single machine, while in other embodiments database 420 might be distributed over a plurality of machines connected by a network, as is well known in the art. In some embodiments database 420 might be a relational database (e.g., Oracle, DB2, etc.), as is well understood in the art, while in other embodiments database 420 might be another kind of database (e.g., object-oriented database, hierarchical database, etc.)

Processor 430 receives information from input device 410 and receiver 415, as disclosed above, and performs the logic of the methods of FIG. 2 and FIG. 3 (i.e., tasks 230-250 and 330-370, respectively) by submitting queries to database 430, as is well known in the art. Processor 430 also constructs redirection messages and cancel redirection messages, as disclosed above, and sends these messages to transmitter 440.

Transmitter 440 receives redirection messages and cancel redirection messages from processor 430, as disclosed above, and transmits these messages to the PSTN or the Internet, as appropriate (tasks 260 and 380, respectively). As will be clear to those skilled in the art, in some embodiments, transmitter 440 might interface directly with the PSTN/Internet, while in other embodiments, transmitter 440 might transmit the messages in another fashion (e.g., over a data network to another server that is connected to the PSTN/Internet, etc.).

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A method for automatically forwarding a signal directed to a user's mobile communications device to one of a plurality of airplane communications devices, said method comprising:
(a) receiving a first contact identifier corresponding to said mobile communications device;
(b) determining a second contact identifier corresponding to said airplane communications device associated with said user; and
(c) sending a forwarding message that causes a signal directed to said first contact identifier to be forwarded to said second contact identifier.

2. The method of claim 1 wherein (a) comprises:
(i) receiving an identifier associated with said user; and
(ii) determining said first contact identifier based on said identifier.

3. The method of claim 2 wherein (i) comprises reading a signal from an item selected from the group consisting of: flight ticket, flight ticket receipt, boarding pass, frequent flyer card, passport, identification card, credit card, and driver's license.

4. The method of claim 1 wherein (b) comprises:
(i) receiving an airplane identifier and an airplane seat identifier associated with said user; and
(ii) determining said second contact identifier based on said airplane identifier and said airplane seat identifier.

5. The method of claim 4 wherein (i) comprises reading a signal from an item selected from the group consisting of: flight ticket, flight ticket receipt, boarding pass, frequent flyer card, passport, identification card, credit card, and driver's license.

6. The method of claim 4 wherein (i) comprises:
receiving a flight identifier; and
determining said airplane identifier based on said flight identifier.

7. An apparatus comprising:
a processor for associating:
a first contact identifier corresponding to a mobile communications device with
a second contact identifier corresponding to one of a plurality of communications devices on board an airplane; and
a transmitter for sending a forwarding message that causes a signal directed to said first contact identifier to be forwarded to said second contact identifier.

8. The apparatus of claim 7 wherein said processor is also for:
(i) receiving a user identifier associated with a user; and
(ii) determining said first contact identifier based on said user identifier.

9. The apparatus of claim 8 wherein said transmitter sends said forwarding message when said apparatus receives a boarding signal comprising said user identifier.

10. The apparatus of claim 8 further comprising an input device for reading said user identifier from an item selected from the group consisting of: flight ticket, flight ticket receipt, boarding pass, frequent flyer card, passport, identification card, credit card, and driver's license.

11. The apparatus of claim 10 wherein said transmitter sends said forwarding message when said input device receives said user identifier.

12. The apparatus of claim 8 wherein said processor is also for:
(i) receiving an airplane identifier and an airplane seat identifier associated with said user; and
(ii) determining said second contact identifier based on said airplane identifier and said airplane seat identifier.

13. The apparatus of claim 12 further comprising a memory for storing at least one of:
at least one of said user identifiers;
at least one of said contact identifiers corresponding to a respective one of said mobile communications devices;
at least one of said airplane identifiers;
at least one of said airplane seat identifiers;
at least one of said contact identifiers corresponding to a respective one of said airplane communications devices;
at least one association between:
one of said user identifiers, and
a respective one of said contact identifiers corresponding to a respective one of said mobile communications devices; and
at least one association between:
one of said airplane identifiers,
one of said airplane seat identifiers, and
a respective one of said contact identifiers corresponding to a respective one of said airplane communications devices.

14. The apparatus of claim 7 wherein:
said transmitter is also for sending a cancel forwarding message that causes a signal directed to said first contact identifier to no longer be forwarded; and
said transmitter sends said cancel forwarding message when said apparatus receives a deplaning signal.

15. The apparatus of claim 14 wherein said deplaning signal is sent when the earlier of the following events occurs:
said airplane arrives at an airport gate; and
a timeout.

16. A method for automatically terminating forwarding of a signal directed to any of a nonempty set of mobile communications devices, said method comprising:
(a) receiving a deplaning signal comprising a flight identifier associated with an airplane;
(b) determining, based on said flight identifier, at least one contact identifier corresponding to a respective one of said mobile communications devices; and
(c) sending at least one cancel forwarding message that causes a signal directed to at least one of said contact identifiers to no longer be forwarded.

17. The method of claim 16 wherein (b) comprises:
(i) associating said flight identifier with at least one user identifier; and
(ii) associating said user identifier with a respective one of said contact identifiers.

18. The method of claim 17 wherein said deplaning signal is sent when the earlier of the following events occurs:
said airplane arrives at an airport gate; and
a timeout.

19. A method for automatically causing
a message sent to a first user by a second user associated with said first user to be directed to
a contact identifier corresponding to one of a plurality of airplane communications devices,
said method comprising:
(a) receiving a user identifier corresponding to said first user;
(b) determining said contact identifier of said airplane communications device associated with said user identifier; and
(c) sending a notification message to said second user, wherein said notification message specifies said contact identifier as a current contact identifier for said first user.

20. The method of claim 19 wherein (a) comprises reading a signal from an item selected from the group consisting of: flight ticket, flight ticket receipt, boarding pass, frequent flyer card, passport, identification card, credit card, and driver's license.
